(19) United States
(12) Patent Application Publication
(10) Pub. No.: US 2003/0008703 A1
(43) Pub. Date: Jan. 9, 2003

(54) Gaming system using a portable gaming device

(76) Inventor: Michael Gauselmann, Espelkamp (DE)

Correspondence Address: Brian D. Ogonowsky, Patent Law Group LLP, Suite 223, 2635 North First Street, San Jose, CA, 95134-2049, US

(21) Appl. No.: 10/142,105

(22) Filed: May 8, 2002

(30) Foreign Application Priority Data
Jul. 4, 2001 (DE) 101 32 472.3

(51) Int. Cl. A63F 13/00

(52) U.S. Cl. 463/20

(57) ABSTRACT

The gaming system of the present invention uses a portable gaming device and a central unit. The central unit comprises a central control unit, a storage device, and a wireless communication device. The portable gaming device comprises a video display, a control element, a power supply, a second communication device, and a control unit. A player inserts credit into the central unit or into the portable gaming device and is allowed to select a game program. A player may then play the selected game on the portable gaming device. The portable gaming device may play any of a variety of games offered by the central unit.

### FIELD OF INVENTION

The invention is related to a gaming system and in particular a gaming system using portable gaming devices.

### BACKGROUND

From the German publication DE 195 00 806.C2, a gaming system is known that comprises a stand alone central unit with a microprocessor controlled control unit and money handling device as well as a plurality of portable gaming devices that are not equipped with a money handling device. The portable gaming devices are stored in holders near the central unit and have contact via wiring pins in the holders to establish data transfer with the central unit and to recharge their batteries. The control unit of each portable gaming device and the control unit of the central unit are built so that they transfer credit card information, data of winning situations, and game control data regarding play time and the number of games.

The game control data is transferred to the central unit so that the data can be checked. In the case of winning game data, the central unit provides an award to the player. The portable gaming devices are large and heavy because the mechanical display means is in the form of wheels, reels, or flip cards and because of the necessary large and powerful batteries. Furthermore, only one game type can be implemented in each portable gaming because of the dedicated hardware and software in each device and because of the explanations and the pictures of the game system printed on the front glass.

It is the task of the present invention to develop a gaming system in a way that the portable gaming devices become more compact and efficient.

### SUMMARY

The gaming system of the present invention comprises a central unit and at least one portable gaming device. In one embodiment, the central unit comprises a player input device for providing credit, a central control unit, a central storage device, and a communication device. The portable gaming device comprises a display, a control element, a power supply, a communication device, and a control unit.

In one embodiment, the portable gaming device receives credit and game data during operation, real time, via a bi-directional connection with the central unit, which enables a variety of game programs to be played on the portable gaming device.

All commands from the control element during the game are sent from the portable gaming device to the central unit via the bi-directional connection. The central unit then processes the commands and sends a signal back to the portable gaming device to update the game and/or monitor.

In an alternative embodiment, all the required or desired games may be downloaded from the central unit to the portable gaming device.

### BRIEF DESCRIPTION OF THE DRAWINGS

FIG. 1 illustrates a central unit in accordance with one embodiment of the present invention.

FIG. 2 illustrates a portable gaming device in accordance with one embodiment of the present invention.

FIG. 3 is a block diagram of a portable gaming device in accordance with one embodiment of the present invention.

### DETAILED DESCRIPTION

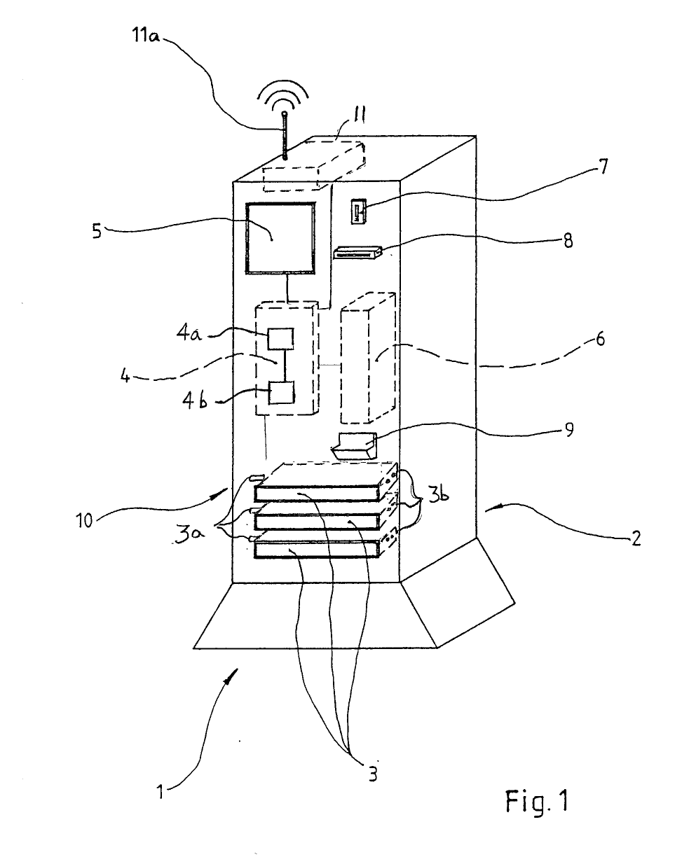

FIG. 1 illustrates a gaming system 1 in accordance with one embodiment of the present invention, comprising a central unit 2 with a plurality of extractable and portable gaming devices 3. The central unit 2 comprises a central control unit 4, which controls a display 5. The control unit 4 comprises a microcomputer system 4a and a central storage device 4b.

A player input device 6 for providing credit is connected to the central control unit 4. The player input device 6 may comprise a coin acceptor, a bill acceptor, a card reader (smart card reader, bar code reader, credit/debit card reader), or any combination thereof For example, in the front of the central unit 2, there is a coin slot 7 and, beneath, an opening 8 for the bill acceptor. Beneath the opening 8, there is a coin bowl 9.

Beneath the coin bowl 9, there are holders 10 for portable gaming devices 3. The holders 10 comprise lock elements 3a, which can be activated by the central control unit 4. Lock elements 3a may be solenoid latches or magnets that latch or unlatch the portable gaming devices 3 to and from the holders 10 upon payment into the central unit 2. The portable gaming devices 3 may be unlatched in sequence, for example, from top to bottom.

Furthermore, each holder 10 has contact terminals 3b, which correspond with pins of the portable gaming device 3. By using the contact terminals 3b, the battery of the portable gaming device 3 can be recharged.

The central control unit 4 is connected to a communication device 11. The antenna 11a of the communication device 11 is attached to the housing of the central unit 2.

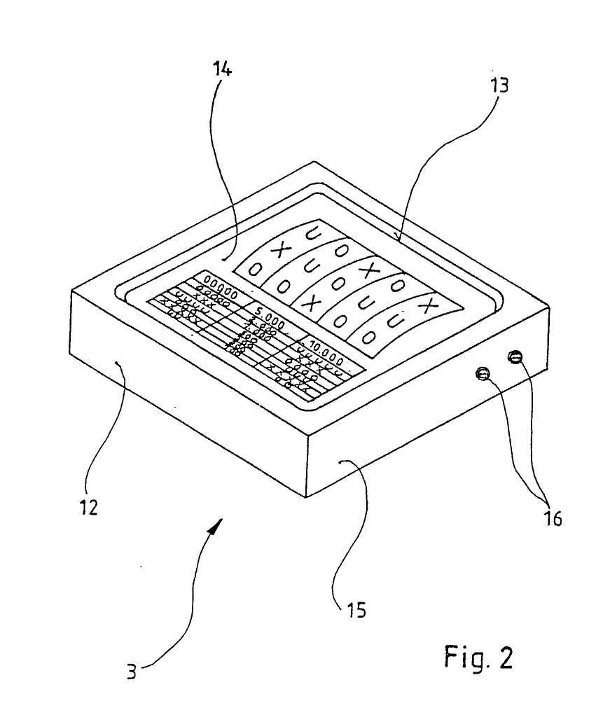

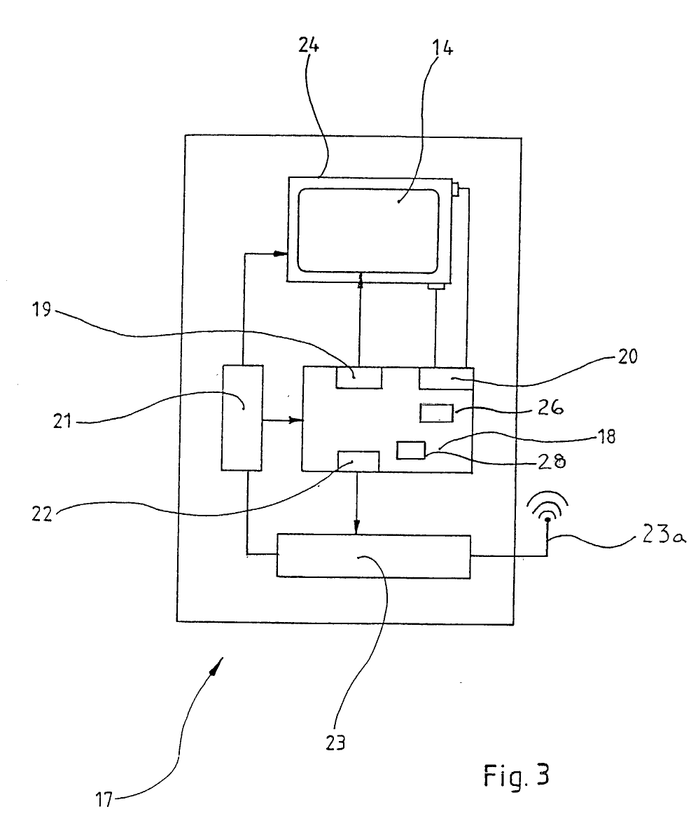

FIG. 2 shows an extractable portable gaming device 3 in accordance with one embodiment of the present invention. The gaming device 3 comprises a housing 12 with an opening 13 to reveal an LCD monitor 14 with a control element 24 (FIG. 3), which can be a pressure and/or touch sensitive sensor. It should be understood that any input device such as a keyboard, mouse, trackball, buttons, or a mechanical handle may be used as control element 24. On the front 15 of the housing 12 there are two pins 16 for recharging the battery 21. The pins 16 correspond to the contact terminals 3b in the central unit 2.

The portable gaming devices are of particularly small volume, lightweight, and inexpensive. Because of the LCD monitor 14, it is possible to select from a multitude of predetermined games during operation of the gaming device 3. The particular game displayed on the LCD monitor 14 in FIG. 2 is a video reel type game, where awards are paid to the player for certain symbol combinations. A pay table is also shown on the monitor 14.

FIG. 3 is a block diagram 17 of one embodiment of the gaming device 3. The control element 24 and the LCD monitor 14 are connected to a control unit 18 located within the housing 12. Additionally, a communication device 23 (e.g., a local area network (LAN) receiver) is connected to the control unit 18 and a battery 21. Because of the small power consumption of the LCD monitor 14 and the communication device 23, a sufficient operation time of the portable gaming device 3 is possible when a small battery 21 is used.

The control unit 18 comprises a microcomputer 26, a storage device 28, a controller 19 that operates the LCD monitor 14, and a controller 20 that interfaces with the control element 24. The battery 21 is the power supply for the control unit 18, the LCD monitor 14, the control element 24, and the communication device 23. The control unit 18 further comprises an interface 22, which is connected to the communication device 23. Bi-directional communication between the portable gaming device 3 and the central unit 2 is established via a wireless LAN network. The antenna 23a of the communication device 23 is attached to the housing 12 of the portable gaming unit 3.

In one embodiment, the games that can be chosen are shown on the central unit display 5 (FIG. 1). The player deposits money or a monetary equivalent into the central unit 2 to receive credits on a portable gaming device 3. The player chooses a game by touching the screen of the display 5, assuming the display 5 has a touch-screen. The chosen games are enabled in the portable gaming device 3 via the wireless connection. Thereafter, the central control unit 4 unlocks the locking element 3a for one of the gaming devices 3. The unlocked gaming device 3 can then be taken out of the holder 10 of the central unit 2 and is functional for playing the chosen game(s).

In one embodiment, there is a constant bi-directional data transfer between the central unit 2 and the gaming device 3 via the wireless LAN connection. All the credits are transmitted from the central unit 2 to the portable gaming device 3 at the beginning of the game. Game data is transferred back and forth between the portable gaming device 3 and the central unit 2. For example, the specific credits of the game are debited and credited by operation of the game, and this data is transmitted/received via the LAN connection. Game data may also include data transmitted to the portable gaming device 3 to change the monitor 14 image as the game progresses, or data may be transmitted to the central unit 2 to convey an action by the control element 24. Because of the wireless connection to the central unit 2, there is a constant update of the game data, and the player is always informed about his current credit amount.

In another embodiment of the present invention, when credit is inserted into the player input device 6, the central control unit 4 activates a basic menu on the LCD monitor 14 of the portable gaming device 3 to allow a player to select a game using the control element 24. The control device 18 of the gaming device 3 includes a powerful microprocessor and large memory so that all the required or desired games can be downloaded from the central unit 2 to the portable gaming device 3 via the LAN. The control unit 18 can then carry out the functions of the game independently of the central unit 2 (except for the credit transfers at the end of the session).

In an alternative embodiment, the program data is downloaded from the central unit 2 to the portable gaming device 3 after a desired game is chosen at the central unit 2. The game may be selected from a touch screen forming display 5 on central unit 2. The control unit 18 then carries out the selected game. All commands from the control element 24 during the game are sent from the portable gaming device 3 to the central unit 2 via the wireless LAN, and the central unit 2 then processes the commands and sends a signal back to the portable gaming device 3 to update the game and/or LCD monitor 14. The bi-directional data transfer ensures a convenient game play. Alternately, the game program may be downloaded onto the portable gaming device 3 for independent operation. Many other techniques may be used to carry out a game program from the portable gaming device 3.

The portable gaming device may also include a card/ticket reading device for reading a player card or other monetary equivalent to provide credits via the portable gaming device. In this manner, the player need not return to the central unit 2 to deposit more money if the player's credit runs out.

When the player is finished playing the game(s), the player reinserts the portable gaming device 3 in the holder 10. This is sensed by the central unit 2, such as by a switch or by the contact terminals 3b, and the central unit 2 outputs to the coin bowl 9 the proper number of tokens for the credits accumulated during play of the portable device 3. An award may also be given via a card or another cashless gaming technique.

Implementation of the above system is well within the skills of those skilled in the art without undue experimentation.

While particular embodiments have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

What is claimed is:

1. A gaming system comprising:
a central unit comprising a central control unit, a storage device, and a wireless communication device; and
a hand-held portable gaming device comprising a video display, a control element, a power supply, a second wireless communication device, and a control unit, said portable gaming device being configured to transmit and receive game data to and from said central unit to enable operation of any of a plurality of games to be played on said portable gaming device.

2. The gaming system of claim 1 wherein said central control unit further comprises a central unit display for displaying a selection of games to be played on said portable gaming device.

3. The gaming system of claim 1 wherein said central unit further comprises a portable gaming device holder having terminals that recharge a battery in said portable gaming device.

4. The gaming system of claim 3 wherein said central unit comprises a player input device for providing credit to play one or more games, and wherein said portable gaming device holder comprises a locking element that unlocks said portable gaming device when said player deposits money or a monetary equivalent into said player input device.

5. The gaming system of claim 1 wherein said power supply is a battery.

6. The gaming system of claim 5 wherein said portable gaming device comprises contact terminals for recharging said battery.

7. The gaming system of claim 1 wherein said central unit further comprises a player input device for providing credit to play one or more games, said player input device comprising at least one of a coin slot and a bill acceptor.

8. The gaming system of claim 1 wherein said first communication device and said second communication device transfer game data during play of a game.

9. The gaming device of claim 1 wherein said portable gaming device is configured to download game programs from said storage device via said bi-directional connection.

10. The gaming system of claim 1 wherein said central unit activates a menu of game programs which is shown on said display of said portable gaming device to allow a player to select a game to be played.

11. The gaming system of claim 1 wherein said central unit further comprises a central display, and wherein said central unit displays a menu of game programs for selection by a player to be played on said portable gaming device.

12. The gaming system of claim 1, wherein said control element is a touch sensitive screen.

13. The gaming system of claim 1 wherein said central unit further comprises an award output mechanism for providing an award to said player after playing a game on said portable gaming device.

14. The gaming system of claim 13 wherein said award is coins.

15. A method of operating a gaming system comprising:
depositing a monetary amount into a central unit;
providing credit by said central unit to a portable gaming device via a bi-directional wireless connection between said central unit and said portable gaming device;
displaying a selection of game programs;
enabling a selected game program to be played on said portable gaming device; and
providing an award to said player by said central unit.

16. The method of claim 15 further comprising unlocking said portable gaming device from said central unit.

17. The method of claim 15 further comprising downloading a selected game program from said central unit to said portable gaming device after said displaying a selection of game programs.

18. The method of claim 15 wherein said displaying a selection of game programs is performed on a display on said portable gaming device.

19. The method of claim 15 wherein said displaying a selection of game programs is performed on a display on said central unit.

20. The method of claim 15 wherein said depositing a monetary amount comprises depositing at least one of coins, bills, and cards.

21. The method of claim 15 wherein said central unit unlocks said portable gaming device from a holder after said player deposits said monetary amount into said central unit.

22. The method of claim 15 further comprising transferring game data during play of a game via said wireless connection.

23. The method of claim 15 further comprising downloading game programs from said central unit to said portable gaming device via said wireless connection.

24. The method of claim 15 further comprising entering player commands via a touch sensitive screen on said portable gaming device.

25. The method of claim 15 wherein said award is coins.
